(19) United States
(12) Patent Application Publication
(10) Pub. No.: US 2025/0220261 A1
(43) Pub. Date: Jul. 3, 2025

(54) DYNAMIC FREQUENCY CAP FOR CONTENT DELIVERY

(71) Applicant: Microsoft Technology Licensing, LLC, Redmond, WA (US)

(72) Inventors: Tao Cai, Sunnyvale, CA (US); Yaolin Wang, Santa Clara, CA (US); Yingxia Shi, Sunnyvale, CA (US); Xi Xiong, Santa Clara, CA (US); Mamta Jayashinh Patil, Alameda, CA (US)

(21) Appl. No.: 18/400,975

(22) Filed: Dec. 29, 2023

(51) Int. Cl. H04N 21/262; G06Q 10/04

(52) U.S. Cl. CPC H04N 21/26266; G06Q 10/04

(57) ABSTRACT

Systems and methods are directed to selecting and delivering targeted content. In response to a request from a user, a central control component accesses content delivery data and content provider settings. Based on the content delivery data and the content provider settings, the central control component generates content delivery settings that include a plurality of frequency capping (Fcap) rules. The content delivery settings are transmitted to a serving system. A determination component of the serving system accesses user data associated with the user that indicates user preferences. Based on the content delivery settings and the user data, the determination component selects a piece of content to deliver to the user. A delivery component then delivers the piece of content to the user.

### TECHNICAL FIELD

The subject matter disclosed herein generally relates to content delivery. Specifically, the present disclosure addresses systems and methods that dynamically determine and apply frequency capping (Fcap) for content delivery.

### BACKGROUND

In a content delivery system, specific content should be delivered to a user in a manner that satisfies a content provider's settings and resources. However, a user may not want to view the same content or similar content (e.g., same formatted content) repeatedly within a given period of time. In one case, a first component may determine to speed up content delivery, while a second component may determine to slow down content delivery in contrast to the first component. This results in a brain split situation where two components want to trigger opposing operations. This technical problem gets exacerbated when attempting to determine and delivery content in real-time or near real-time, as well as by the number of signals that are used to control content delivery.

Additionally, conventional content delivery systems do not consider what is best for the user. A number of five impressions for a user during a 48-hour period may be bad for a first user who has no interest in the content, but the same number of impressions for a second user whose expressed interest may be a good thing that can drive conversions.

### BRIEF DESCRIPTION OF THE DRAWINGS

Some implementations are illustrated by way of example and not limitation in the figures of the accompanying drawings.

FIG. 1 is a diagram illustrating a network environment suitable for dynamically adjusting frequency of content delivery, according to some example implementations.

FIG. 2 is a block diagram illustrating components of a conventional content delivery system that uses static frequency capping rules for content delivery.

FIG. 3 is a block diagram illustrating components of a system for dynamically adjusting frequency of content delivery, according to some example implementations.

FIG. 4 is a block diagram illustrating components of another system for dynamically adjusting frequency of content delivery, according to some example implementations.

FIG. 5 is a block diagram illustrating components of a serving system, according to some example implementations.

FIG. 6 is a block diagram illustrating components of a central control component that uses machine learning to derive content delivery settings, according to some example implementations.

FIG. 7 is a flowchart illustrating operations of a method for dynamically adjusting frequency of content delivery, according to some example implementations.

FIG. 8 illustrates a flowchart illustrating operations of another method for dynamically adjusting frequency of content delivery, according to some example implementations.

FIG. 9 is a block diagram illustrating components of a machine, according to some example implementations, able to read instructions from a machine-storage medium and perform any of the methodologies discussed herein.

### DETAILED DESCRIPTION

The description that follows describes systems, methods, techniques, instruction sequences, and computing machine program products that illustrate example implementations of the present subject matter. In the following description, for purposes of explanation, numerous specific details are set forth in order to provide an understanding of various implementations of the present subject matter. It will be evident, however, to those skilled in the art, that implementations of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

Example implementations provide systems and methods that use dynamic frequency capping (Fcap) rules for delivery of content. Fcap rules provides frequency capping control for how many times a user will see the same or similar content within a certain time period (e.g., a certain number of hours). Same or similar content can be from a same content provider or be a same format or type. For example, if a user views a piece of content, a Fcap rule may cause a content delivery system to refrain from showing the same (or similar) piece of content for a particular amount of time.

As user expectations for viewing of content will change, the content delivery system should avoid the use of static and hardcoded Fcap rules, and instead efficiently deliver content based on dynamic determination by a central control component (e.g., a centralized brain) that considers a plurality of signals that can affect a content delivery process. The example implementations apply a dynamic Fcap rule (e.g., dynamically selected or dynamically generated Fcap rule) to content. In some implementations, a central control component is provided that balances the signals including different content provider settings, content delivery data, and/or one or more forecasting curves. The content and content delivery settings can be based on an objective associated with a content provider. For instance, if the objective is to drive user engagement, then different types of content can be shown and/or the content can be delivered differently than if the objective is to drive maximum number of users that see the content provider's content. Thus, the content delivery system can determine an objective/intent as part of a campaign. Additionally, the Fcap rule can be influenced by the content provider's objective.

In one implementation, the forecasting curves forecast resource allocation and/or data traffic over a given time period. The central control component uses these forecasting curves to smoothly delivery a content provider's content by dynamically adjusting the content provider settings and generating dynamic Fcap rules. The information is then transmitted as content delivery settings to a serving system which uses the information along with accessed user data include previously viewed content (if available), interaction data of a user, and/or user preferences to select content to delivery to the user.

In one implementation, the central control component uses a machine learning model trained with prior content provider settings and historical content delivery data. The central control component then applies current content provider settings and current content delivery data to the trained model to generate (dynamic) Fcap rules for content. Further still, the machine learning model, in some implementations, also can generate updated content delivery settings.

Accordingly, the present disclosure provides technical solutions that address the split-brain technical problem and provides practical advantages over conventional systems' use of a static Fcap rule. These advantages and others will be discussed in more detail below.

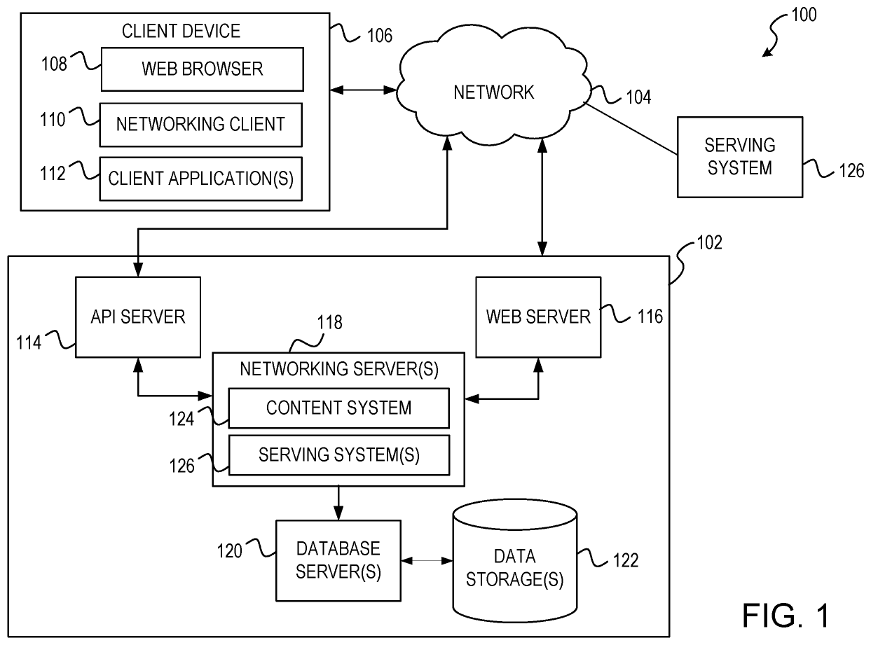

FIG. 1 is a diagram illustrating a network environment 100 suitable for dynamically adjusting frequency of content delivery, according to some example implementations. A network system 102 provides server-side functionality via a communication network 104 (e.g., the Internet, wireless network, cellular network, or a Wide Area Network (WAN)) to one or more client devices 106. In some cases, the client device 106 is a device of a content provider that uses the network system 102 to deliver their content. In other cases, the client device 106 is a device of user that receives content via the network system 102. In example implementations, the network system 102 comprises components that host and manage a content system as will be discussed in more detail below.

The client device 106 interfaces with the network system 102 via a connection with the network 104. Depending on the form of the client device 106, any of a variety of types of connections and networks 104 may be used. For example, the connection may be Code Division Multiple Access (CDMA) connection, a Global System for Mobile communications (GSM) connection, or another type of cellular connection. Such a connection may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, or other data transfer technology (e.g., fourth generation wireless, 4G networks, 5G networks). When such technology is employed, the network 104 may include a cellular network that has a plurality of cell sites of overlapping geographic coverage, interconnected by cellular telephone exchanges. These cellular telephone exchanges may be coupled to a network backbone (e.g., the public switched telephone network (PSTN), a packet-switched data network, or other types of networks).

In another example, the connection to the network 104 may be a Wireless Fidelity (Wi-Fi, IEEE 802.11x type) connection, a Worldwide Interoperability for Microwave Access (WiMAX) connection, or another type of wireless data connection. In such an implementations, the network 104 may include one or more wireless access points coupled to a local area network (LAN), a wide area network (WAN), the Internet, or another packet-switched data network. In yet another example, the connection to the network 104 may be a wired connection (e.g., an Ethernet link), and the network 104 may be a LAN, a WAN, the Internet, or another packet-switched data network. Accordingly, a variety of different configurations are expressly contemplated.

The client device 106 may comprise, but is not limited to, a smartphone, tablet, laptop, multi-processor systems, microprocessor-based or programmable consumer electronics, game consoles, set-top boxes, a server, or any other communication device that a content provider or user may utilize to access the network system 102. In some implementations, the client device 106 comprises a display component (not shown) to display information (e.g., in the form of user interfaces). In further implementations, the client device 106 comprises one or more of a touchscreen, accelerometer, camera, microphone, and/or Global Positioning System (GPS) device.

The client device 106 may include one or more applications (also referred to as “apps”) such as, but not limited to, a web browser 108, a networking client 110, and other client applications 112, such as a messaging application, an electronic mail (email) application, and the like. In some implementations, if the networking client 110 is present in the client device 106, then the networking client 110 is configured to locally provide a user interface for the application and to communicate with the network system 102, on an as-needed basis, for data and/or processing capabilities not locally available. Conversely, if the networking client 110 is not included in the client device 106, the client device 106 may use the web browser 108 to access the network system 102.

In some implementations, a user of the client device 106 accesses the network system 102 in order to access a network platform and network connections (e.g., social network connections). In these implementations, the user may be a member of the network platform. The user can perform searches (e.g., a job searches) on the network platform, view their feeds, make connections, message other members, and perform other operations provided by the network system 102. In various cases, the user can view content (e.g., recommendations, feeds, publications, ads) provided by various content providers. The content can be customized to the user based on their preferences (e.g., user's intent and interests). These preferences can be derived from past content that the user has shown interest in (e.g., interacted with, viewed) and may be machine-learned.

In other implementations, a content provider of the client device 106 accesses the network system 102 in order to view, input, or update their content delivery data. In these implementations, the content provider provides content for distribution by the network system 102 and indicates how they would like their content distributed. The content provider may provide resources for distribution of their content and indicate how they want those resources utilized. For instance, the content provider may indicate an audience size (e.g., number of users they want to reach) or indicate a throttle setting to slow down use of resources and spread the content delivery out over time. The content provider can also indicate a resource usage setting (e.g., bid setting) that controls amount of resources allocated for each content delivery opportunity and a resource amount (e.g., budget). Collectively, the information provided by the content provider forms a content delivery objective or campaign.

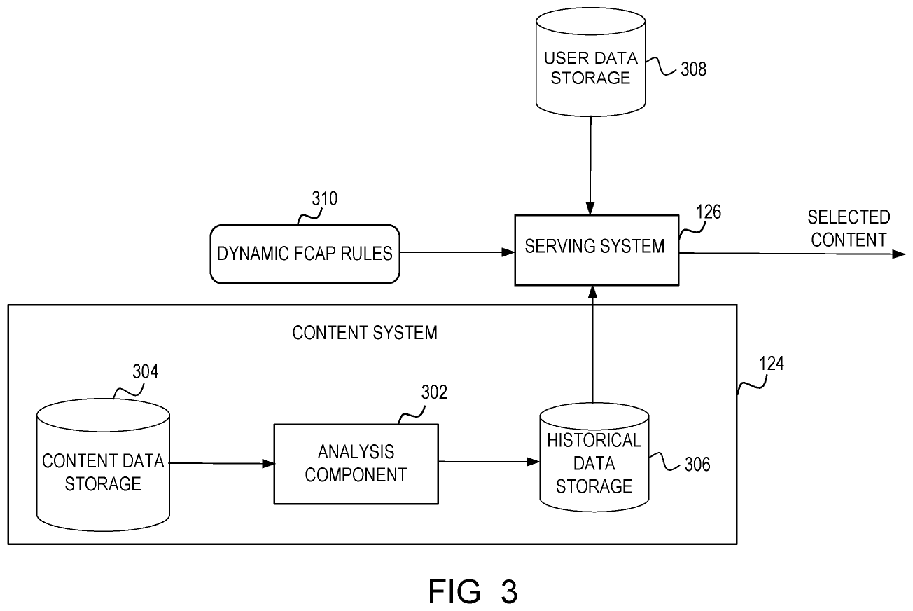

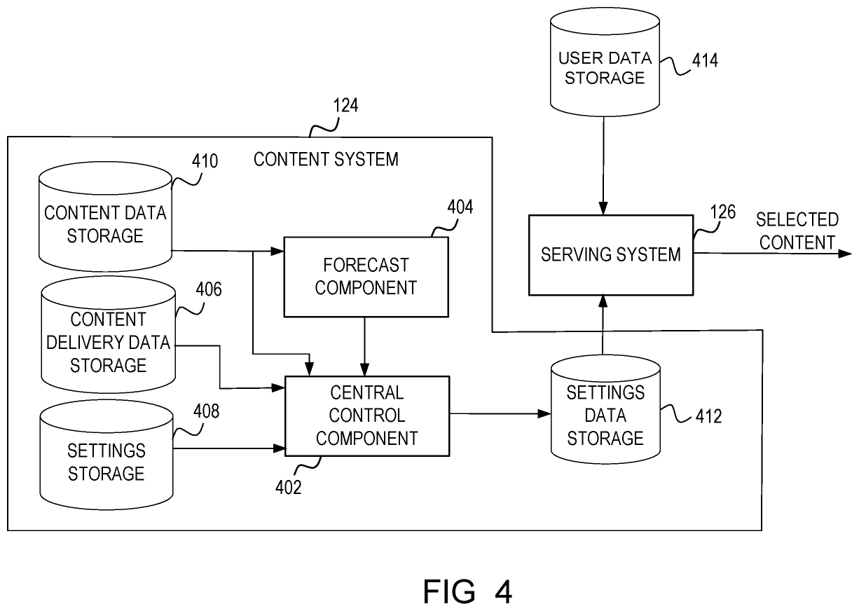

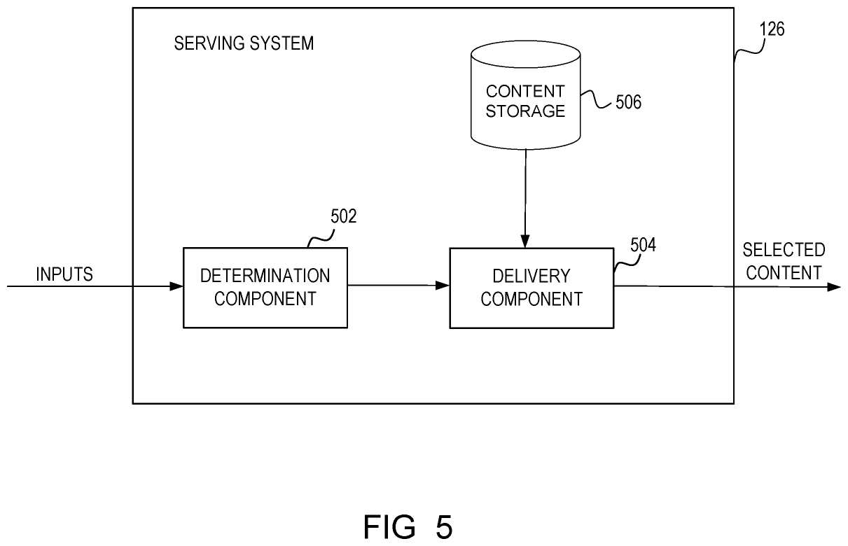

Turning specifically to the network system 102, an application programing interface (API) server 114 and a web server 116 are coupled to, and provide programmatic and web interfaces respectively to, one or more networking servers 118. The networking server(s) 118 host the network platform, which may comprise one or more applications, or engines, or systems and which can be embodied as hardware, software, firmware, or any combination thereof. In example implementations, the networking server 118 comprises a content system 124 that determines historical and/or current content delivery data (e.g., historical or current campaign status) and in some cases, generates dynamic Fcap rules. The content system 124 will be discussed in more detail in connection with FIG. 3 and FIG. 4. In some implementations, the networking servers 118 may also include one or more serving systems 126 (e.g., local or first party serving systems). The serving system 126 will be discussed in more detail in connection with FIG. 5.

The networking servers 118 are, in turn, coupled to one or more database servers 120 that facilitate access to one or more information storage repositories or data storage(s) 122. In one implementation, the data storages 122 are storage devices that store, for example, user data (e.g., user profiles including connections and posts, user preferences, and past interacted with content); content provider settings, content delivery data, and/or past content data that is used by the network system 102.

In some implementations, the network environment 100 may include one or more remote serving systems 126. These serving systems 126 are content serving hosts that are remote from the network system 102 and may be control by a same or different entity than the entity of the network system 102.

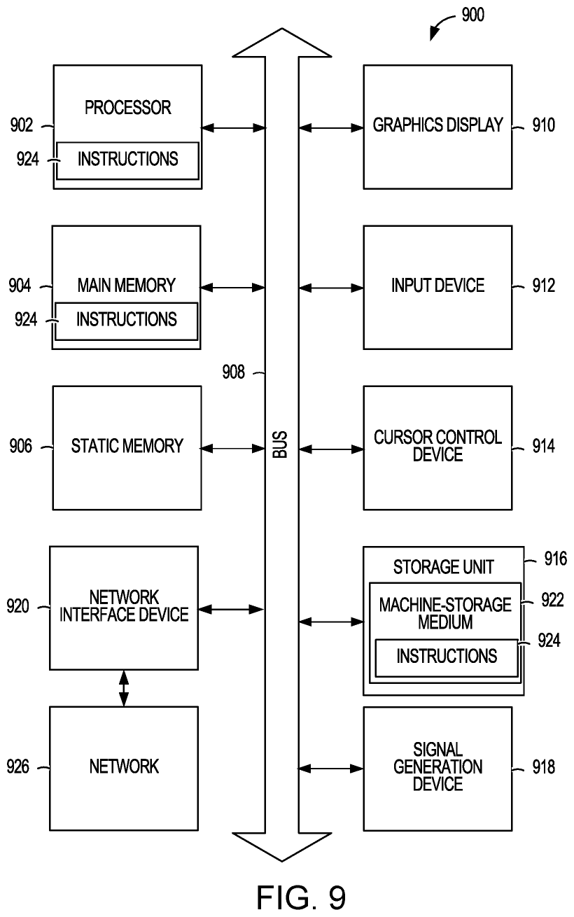

In some implementations, any of the systems, servers, data storage, or devices (collectively referred to as “components”) shown in, or associated with, FIG. 1 may be, include, or otherwise be implemented in a special-purpose (e.g., specialized or otherwise non-generic) computer that is modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 9, and such a special-purpose computer may be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Additionally, any number of user devices 106 and serving systems 126 may be embodied within the network environment 100. While only a single network system 102 is shown, alternative implementations may contemplate having more than one network system 102 to perform server operations discussed herein.

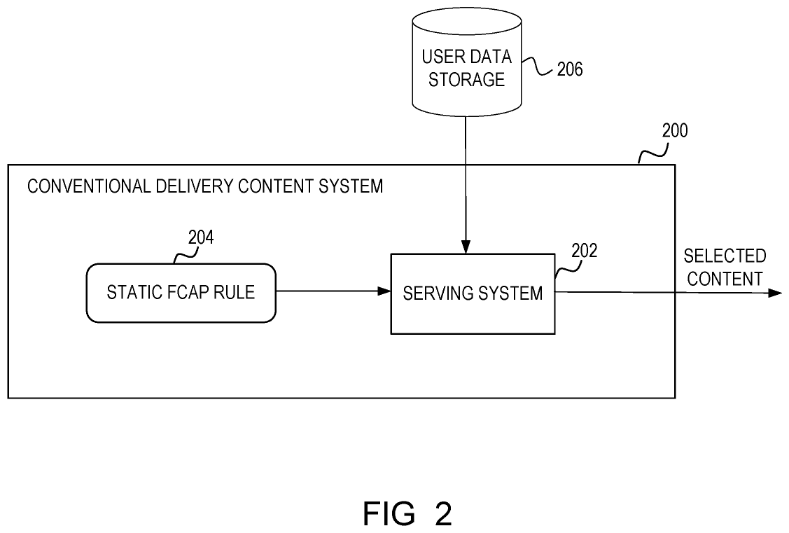

FIG. 2 is a block diagram illustrating components of a conventional content delivery system 200 that uses a static Fcap rule 204 for content delivery, according to some example implementations. The Fcap rule 204 is static in that all content providers regardless of their delivery objectives (e.g., campaigns) use the same Fcap rule 204. For example, the static Fcap rule 204 may be three hours per impression. Additionally, the Fcap rule 204 is hardcoded and does not change based on different situations or settings.

The conventional content delivery system 200 comprises a serving system 202 and the static Fcap rule 204. The serving system 202 determines what content to provide to a user based on corresponding user data from a user data storage 206 and the Fcap rule. In the conventional delivery content system 200, the user data comprises content previously delivered to the user. In one example, the Fcap rule may indicate that a same content or same type of content (also referred to as “impression”) from a content provider should not be shown more than every three hours to the user. Thus, the serving system 202 considers what the user has viewed (e.g., from the user data) and selects content to deliver based on the static Fcap rule 204. For example, assume there are three different pieces of content that can be served to the user. A first piece of content was last served one hour ago, a second piece of content last served three hours ago, and a third piece of content was last served four hours ago to the user. As such, the third piece of content will next be served as it is the only piece of content that satisfies the static Fcap rule 204.

It is noted that the user data does not include user preferences (or the user preferences are not considered) in the convention delivery content system 200. Thus, conventional systems for content delivery do not consider what is best to show the user. Five impressions of the same content for a user during a 48-hour period may be bad for a first user who has no interest in the content, but the same number of impressions for a second user whose expressed interest may be ideal and can drive conversions (e.g., views, click throughs).

Example implementations can dynamically change the Fcap rule that is used in selecting and delivering content based on content delivery feedback, a delivery objective, and user preferences/feedback. For instance, if a user likes to see particular content and has a strong reaction when viewing the same content again, the Fcap rule for this user will be more frequent so that the user will likely engage with the particular content when it is shown a second or third time. Some users engage a first time a particular piece of content is shown, and the piece of content does not need to be shown again to the same user. Alternatively, if the piece of content is shown once to a user and the user shows no interest, the piece of content will not be shown again for a long time (e.g., less frequent Fcap rule). In some implementations, the user's intent/interests can be determined using machine-learning.

In a traditional/conventional system, user's interaction history with content (e.g., impression, click, lead) is collected and used as a source of a machine-learning (ML) model. The ML system learns the relationships between content frequency and user's intent and interest in the content for each user and each content. Higher intent/interest leads towards a higher click through rate, so different frequencies drive different click through rates. Different users may show different behaviors, such as some users may lose interest after a first impression and prefer fresh content, while some users may prefer repeated content with the same content (or same content provider). In the traditional system, those user behaviors can be learned and only used in predicting a click through rate (or other prediction models) to better predict the user engagement.

In example implementations having dynamic Fcap rules, the system learns user's behavior and selects a more optimal dynamic Fcap rule. For example, M1 is a member or user who prefers viewing repeated content and has viewed a first piece of content (C1) one hour ago. In the traditional system, due to the static Fcap rule, C1 will not be shown to M1 again given its static Fcap rule. In the example implementation having dynamic Fcap rules, due to M1 showing more interest in C1 and M1 having viewed the ad before, the dynamic Fcap rule can be changed for M1 only to less than one hour, so that C1 will be shown to M1 again.

Thus, the dynamic Fcap rule can be customized at a user or member level. For example, a second member or user (M2) only prefers fresh content. Here, example implementations can further reduce the content frequency, so as to recommend more new content to M2. Meanwhile, M1 will experience a different Fcap rule.

Further still, the content provider settings (e.g., associated with a delivery objective or campaign) are considered by the network system 102 in dynamically changing/selecting the Fcap rule to apply. The content provider settings include resources available, resource allocation/usage factors, throttle factors, and/or delivery objective(s) for their content. For example, the content provider settings may indicate an audience size that the content provider wants to reach, a length for a content delivery campaign, an amount of resources available for each interaction (e.g., view, click through), and so forth. In order to meet the delivery objectives and goals, the Fcap rules that are applied can be dynamically adjusted throughout a campaign or between different campaigns.

Over increase in frequency will hurt a user's experience if they are continually shown content that they are not interested in and it is a waste of a content provider's resources. Thus, user intent and interests (also referred to as “user preferences”) as well as a content provider's objectives and intents need to be considered by the network system 102. As such, example implementations provide a content system 124 that dynamically adjusts the Fcap rule based on content delivery status and considers user preferences and content provider's objectives. Content that has great delivery, a large audience, and performs well (e.g., a high view or high click through rate), will cause the content system 124 to decrease the frequency in order to slow down the delivery of the same content to the same members. Increasing frequency will speed up delivery of the content and reducing the frequency will slow down delivery but deliver to more users.

Example implementations apply different Fcap rules (e.g., more delivery, normal delivery, less delivery) based on content delivery data for different pieces of content and/or campaigns. FIG. 3 is a block diagram illustrating components of a system for dynamically adjusting frequency of content delivery, according to some example implementations. In one implementation, the content system 124 comprises an analysis component 302, a past content data storage 304, and a historical data storage 306. In other implementations, the serving system 126 may be local to the analysis component 304 and included in the content system 124.

In example implementations, the analysis component 302 periodically processes offline jobs to learn or generate historical content delivery data. The analysis component 302 accesses content data from the content data storage 304. The content data can comprise, for example, previous content provider resources or budgets, previous content delivery performance, audience reached with each piece of content, and so forth. The analysis component 302 uses the content data to generate/learn the historical content delivery data that indicates resource usage (e.g., spending) and delivery over a previous period of time (e.g., last three days) including, for example, one or more utilization scores (e.g., budget utilization) and content delivery performance with different day sliding windows. The historical content delivery data may then be stored to the historical data storage 306.

In example implementations, the historical content delivery data is provided to the serving system 126 prior to any serving request from a user. The serving system 126 loads the historical content delivery data into its memory so that the serving system 126 does not need to fetch the historical content delivery data from a remote store when the serving request is received. This reduces latency in determining and delivering content in response to the serving request.

When a request from the user comes in, the serving system 126 fetches user data from a user data storage 308. In some cases, the user data storage 308 is a part of the serving system 126. In other cases, the user data storage 308 is accessed by the serving system 126 and is located elsewhere in the networking environment 100. The user data comprises viewed content history (content that was previously delivered to the user and when it was delivered) and user preferences. For example, the user preferences can indicate whether the user prefers to see certain content in higher frequency or only wants to see certain content once and loses interest going forward. In some implementations, the certain content are advertisements or publications. In example implementations, the user preferences are learned through machine-learning based on past content delivered and interacted (or not interacted) with by the user.

Instead of applying a static Fcap rule as in the conventional implementation discussed in FIG. 2, the system of FIG. 3 applies different Fcap rules 310 dynamically. A Fcap rule is selected from the set of dynamic Fcap rules 310 based on the historical content delivery data and in some cases, the user data. Although the different FCap rules can be very dynamic and should be different between pieces of content, in the implementation of FIG. 3, each content provider delivery objective (e.g., campaign) can be broken into multiple pre-defined FCap settings. For example, the serving system 126 can use 48 hours an impression for a first user for good performance campaigns and use 24 hours an impression for a second user for bad performance campaigns which may generate one conversion after multiple impressions.

The dynamic Fcap rules 310 may be accessed and/or stored to the serving system 126. In some cases, the dynamic Fcap rules 310 may be pushed to the serving system by the content system 124. In the implementations of FIG. 3, the dynamic Fcap rules 310 are predetermined prior to receiving the request, but dynamically selected in response to the request and based on the historical content delivery data and, in some cases, the user data. For example, a first Fcap rule applies one hour per impression if frequency should be increased based on the historical content delivery data; a second Fcap rule applies three hour per impression if normal delivery frequency should be used based on historical content delivery data; and a third Fcap rule applies six hour per impression if frequency should be decreased based on historical content delivery data.

Based on the user data (e.g., when the user viewed each piece of content), the serving system 126 selects the piece of content to deliver to the user in response to the request. As an example, a first piece of content (C1) may have a utilization score that is too low (0.5) resulting in a need to increase frequency (e.g., apply first Fcap rule of one hour per impression); a second piece of content (C2) may having a normal utilization score (1.0) resulting in a standard Fcap rule being applied (e.g., second Fcap rule of three hour per impression); and a third piece of content (C3) may have a high utilization score (1.1) resulting in a decreased frequency (e.g., apply third Fcap rule of six hour per impression). In one implementation, the utilization score is a budget utilization score associated with the content provider. In other implementations, audience size, bidding, pacing, or other factors can be used instead of the utilization score in determining which Fcap rule to apply. Assume, based on the user data that C1 was last viewed 2 hours ago; C2 was last viewed 3 hours ago; and C3 was last viewed 4 hours ago. For the above example, C2 and C3 are frequency capped and C1 is not frequency capped. Thus, C1 will be served to the user.

The implementation of FIG. 3 processes offline jobs and pushes the historical content delivery data to the serving system 126 for storage prior to receiving the request. In some cases, the request may not come in for a large period of time. Thus, the historical content delivery data can be outdated or stale.

Additionally, the implementation of FIG. 3 only considers a single signal of the business objective or campaign. There may be many other signals on a campaign level such as a resource usage factor (e.g., bidding price) or a throttle factor. Throttle controls a number of content delivery opportunities that are considered. For example, if a throttle factor is set to 0.9, then 90% of content delivery opportunities are ignored and only 10% of the opportunities are considered. This can slow on resource usage (e.g., spend) so as to not exhaust resources (e.g., a budget) quickly and smooth out delivery over a period of time. In some implementations that use bidding, a bid price may be offered for each content delivery opportunity that is considered, whereby multiple content providers may be bidding for the same content delivery opportunity.

If a campaign spend is good, the bid price may go lower and lower. Alternatively, if the campaign is having trouble reaching delivery goal, then the campaign spend price may increase. Thus, this campaign setting (e.g., content provider setting) causes the bid price to try to control the delivery speed. However, the FCap rules also influence the delivery speed. As such, if a component, based on Fcap rules, thinks the campaign needs to speed up delivery while a second component, based on the bid price and current content delivery data, thinks the campaign needs to slow down, there are two “brains” making the content delivery decision resulting in a potential brain split problem.

To address both the timeliness of the content delivery data and the split-brain problem, another system for dynamically adjusting frequency of content delivery is discussed in FIG. 4. The example implementation of FIG. 4 considers a plurality of different signals in a central manner to avoid potential brain split issues. In particular, the content system 124 comprises a central control component 402 that acts as a central brain by receiving signals from different data sources and making a central decision for Fcap rules, resource usage (e.g., bid), throttle, and/or other signals for different campaigns. The input signals can include real-time (or substantially real-time) data. In example implementations, the input signals include one or more forecasting curves generated by a forecast component 404 and data accessed from a content delivery data storage 406 and a content provider settings storage 408.

The forecast component 404 generates forecasting curves based on past content data accessed from a content data storage 410. For instance, traffic is not stable. There may be more traffic in the morning but less traffic late at time. Therefore, the forecast component 404 can generate a forecasting curve that indicates, for example, how data traffic is at various times of the day (e.g., 9 am is 100 k queries per second (QPS); 10 am is 55K QPS). In some implementations, the forecasting curves can be predicted based on geo information (e.g., a geo forecasting curve). For example, if a campaign's audience is from the US, then the forecasting curve is a US traffic curve. The geo forecasting curve can learn past delivery information (e.g., a volume of members having visited from a particular geography, how similar geography campaigns' delivery paces are). The geo forecasting curve can also consider weekday/weekend and seasonality information.

Ideally, the forecasting curve should be close to a real campaign spending curve, so there are alternative forecasting curve implementations. Another implementation is a targeting expression curve. For example, if a campaign's audience is “java developers,” the targeting expression curve will be all java developers' traffic. Targeting expression forecasting not only uses targeting information, but also uses campaigns' targeting expression information (e.g., interest, industry). The targeting expression curve can be more accurate than the geo forecasting curve because it considers more fine-grained information. However, the downside of targeting expression is that there may be too many targeting expression curves in some rare cases and new setup campaigns may not find a similar targeting expression curve. In these cases, the network system 102 can fall back to using the geo forecasting curve.

The content delivery data storage 406 provides current (e.g., real-time) content delivery data that indicates campaign status of an ongoing campaign. For example, the current content delivery data can include a campaign budget spending situation for a particular content provider and their content. Thus, the content delivery data indicates if the ongoing campaign is on schedule (e.g., meets a forecasting curve projection), behind schedule (e.g., below the curve projection), or ahead of schedule (e.g., higher than the curve projection). If the ongoing campaign is behind schedule, there is a desire to increase resource usage (e.g., spend) in order to meet a content provider's delivery goals. However, if the ongoing campaign is ahead of schedule, then there is a desire to slow down resource usage so as to not exhaust content provider delivery too early. Each ongoing campaign may be associated with a different piece of content (e.g., C1, C2, C3).

The settings storage 408 provides existing content provider settings. These content provider settings are static and may indicate an audience size (e.g., how many users to target) and one or more objectives (e.g., delivery goal such as reach, website visit, drive user engagement, drive maximum number of users that see content) established by the content provider. In some cases, the objective(s) can be implicitly derived by the content system 124 based on historical data associated with the content provider.

The central control component 402 takes all of these input signals and generates Fcap rules in addition to other outputs such as a resource usage factor (e.g., bid price) and throttle factor for each ongoing campaign. Thus, the central control component 402 can dynamically change the content provider settings based on a current status of content delivery for their campaign. Furthermore, the signals can change from time to time. By considering multiple input signals, instead of a single input signal, the central control component 402 can derive more accurate content provider settings. For example, if the throttle factor is set to 0.9 (e.g., a high throttle factor) and the content is under delivered (e.g., not reaching a delivery goal), then, in a next moment, the throttle factor will be decreased (e.g., to almost zero) so that every content delivery opportunity can be considered. Additionally, resource usage (e.g., bid price) can be adjusted. For example, if content delivery speed is good, the resource usage factor can be lowered to obtain cheaper impressions. Conversely, if audience size is small and competition for the content delivery opportunities high, the resource usage factor can be increased. In some implementations, the central control component 402 can auto-bid on behalf of a content provider (e.g., determine a bid price and which opportunities to bid on to maximize performance). By controlling these settings (e.g., resource usage factor and throttle factor), the central control component 402 can ensure campaign delivery is smooth with the forecast(s) (e.g., ensure delivery is at a pace of the forecasting curves from the forecast component 404).

Thus, the central control component 402 controls resource usage by dynamically determining resource usage factors (e.g., bid prices) and throttle factors and controls delivery speed using the dynamically generated Fcap rules. Collectively, the outputs (e.g., Fcap rules, resource usage factors, throttle factors) comprise content delivery settings specific to delivery of content in response to a request from a user. The content delivery settings can also include campaign status derived from the content delivery data and content provider settings (e.g., utilization scores, return on investment). These content delivery settings can be considered live or real-time settings. The generated content delivery settings can be stored to a settings data storage 412 and/or provided to the serving system 126. In example implementations, the generated content delivery settings can be provided to the serving system 126 as soon as they are generated (e.g., in real-time) and are continually updated (e.g., every minute).

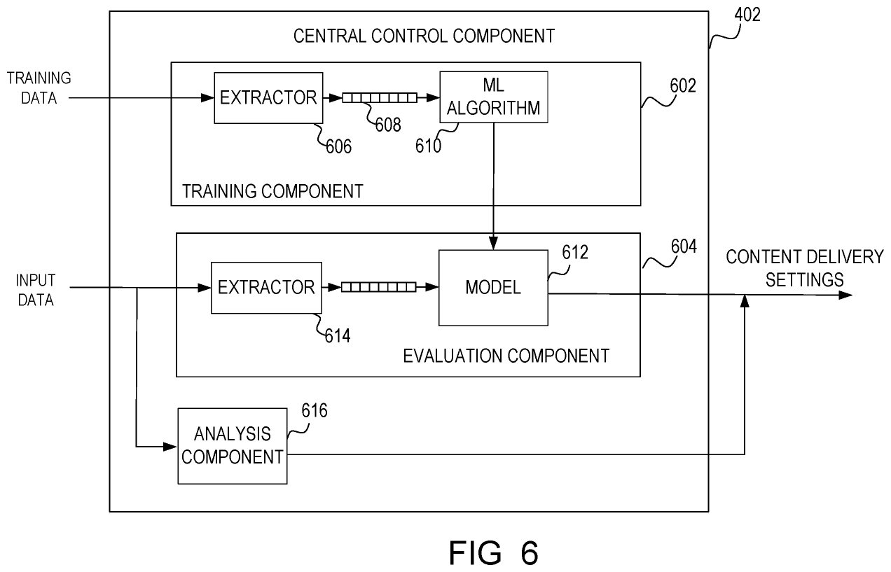

In example implementations, the central control component 402 uses machine learning (e.g., reinforced learning) to determine some of the outputs. Thus, different content providers may have different Fcap rules based on their delivery goals and objective (e.g., content provider settings) and resources (e.g., spending differences). In particular, the central control component 402 determines what is the most important factor(s)/setting(s) and makes adjustments to the settings including generating Fcap rules that satisfies the content providers' objectives. The machine learning aspects of the central control component 402 will be discussed in more detail in connection with FIG. 6 below.

The serving system 126 loads the content delivery settings including the dynamically generated Fcap rules into its memory so that the serving system 126 does not need to fetch the content delivery settings from a remote store when the serving request is received. This reduces latency in determining and delivering content in response to the serving request.

When a request from the user comes in, the serving system 126 fetches user data from a user data storage 414. In some cases, the user data storage 414 is a part of the serving system 126. In other cases, the user data storage 414 is accessed by the serving system 126 and is located elsewhere in the networking environment 100. The user data comprises viewed content history (content that was previously delivered to the user, when the content was deliver, and/or content the user has interacted with) and user preferences. Based on the user data and the content delivery settings (including the Fcap rules), the serving system 126 selects the piece of content to deliver to the user in response to the request.

In one example, bidding and/or throttle factors can influence the content delivery speed. For example, C1 bids $4 and C2 bids at $3 when both campaigns enter the bid auction. Here, C1 will win over C2 and win the auction. If C2 is not reaching its objective (e.g., behind on their schedule), C2 can increase its bid price to $5, so in a future serving opportunity, C2 will win over C1. This same process can apply to C1. For instance, if C1 is ahead of schedule, C1 can reduce its bid price from $4 to $2, so C1 will stop winning future serving opportunities. Given bid/throttle and Fcap control the campaign's delivery speed, it is more efficient to globally optimize the campaign delivery speed through the central brain or central control component 402.

There are differences in the implementation of FIG. 3 and the implementation of FIG. 4. Assuming similar setting for C1, C2, and C3, in the implementation of FIG. 3, delivery of C1 can be sped up by reducing the Fcap frequency or increasing bid independently without considering other signals. In contrast, in the implementation of FIG. 4, the content system 124 optimizes overall delivery through bid/throttle and Fcap together. In the implementation of FIG. 4, the content system 124 can learn the pattern of C1, C2, and C3 and apply different bidding/throttle factors associated with a Fcap rule together. For example, the central control component 402 can create a joint “content delivery setting” including bid price increases from $4 to $5, pacing throttle factor changes from 0.2 to 0.1,Fcap rule changes from 2 hours to 60 minutes. Given different campaigns share different patterns, the central control component 402 can auto-create a more customized “content delivery setting” to better meet each campaign's forecasting curve. One campaign may speed up delivery by increasing the bid while keeping the Fcap; another campaign may speed up delivery by increasing content delivery frequency.

FIG. 5 is a block diagram illustrating components of the serving system 126, according to some example implementations. The serving system 126 may be local to or remote from the content system 124 that provides the selected content to the user. In example implementations, the serving system 126 receives settings and Fcap rules (e.g., inputs), accesses user data for a user, and determines content to deliver to the user based on the Fcap rules. As such, the serving system 126 comprises a determination component 502, a delivery component 504, and a content storage 506.

The determination component 502 receives all the inputs and determines which content to deliver in response to a request based on a plurality of Fcap rules. In some cases, the request is received by the determination component 502. For the implementation of FIG. 3, the determination component 502 accesses the predetermined Fcap rules 310 and the user data (e.g., from the user data storage 308). Based on the historical content delivery data previously stored to the serving system 126 from the content system 124, the determination component 502 applies the different Fcap rules to different content/campaigns. The determination component 502 considers the user data (e.g., when the user has previous viewed each content and any preferences for content) and the applied Fcap rules to select the content to be delivered. Once the content is selected, the delivery component 504 accesses the selected content from the content storage 506 and transmits the selected content to the user.

For the implementation of FIG. 4, the determination component 502 receives the continually updated content delivery settings (e.g., real-time or current content delivery settings) including the dynamically generated Fcap rules from the content system 124. The determination component 502 accesses the user data (e.g., from the user data storage 414) and applies the Fcap rules in combination with other settings (e.g., resource usage factor, throttle factor) and the user data. Based on the Fcap rules and user data, the content is selected. Once the content is selected, the delivery component 504 accesses the selected content from the content storage 506 and transmits the selected content to the user.

FIG. 6 is a block diagram illustrating components of the central control component 402, according to some example implementations. In some implementations, the central control component 402 is configured to train a machine-learning model that during implementation time, determines at least some of the content delivery settings discussed above in connection with FIG. 4. Machine Learning (ML) is an application that provides computer systems the ability to perform tasks, without explicitly being programmed, by making inferences based on patterns found in the analysis of data. Machine learning explores the study and construction of algorithms, also referred to herein as tools, that may learn from existing data and make predictions about new data. Such machine-learning algorithms operate by building an ML model from example training data in order to make data-driven predictions or decisions expressed as outputs or assessments. To enable these operations, the central control component includes a training component 602 and an evaluation component 604.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the model can implement the same relationships when given inputs to generate the corresponding outputs. Unsupervised ML is the training of an ML algorithm using information that is neither classified nor labeled and allowing the algorithm to act on that information without guidance. Unsupervised ML is useful in exploratory analysis because it can automatically identify structure in data.

The training component 602 uses a feature extractor 606 to extract one or more features 608 from training data. The training data is obtained past content from the past content data storage 410. In some example implementations, the training data comprises labeled data with examples of values for the features 608 and labels indicating the outcome. Each feature 608 is an individual measurable property of a phenomenon being observed. The concept of the feature 608 is related to that of an explanatory variable used in statistical techniques such as linear regression. Choosing informative, discriminating, and independent features is important for effective operation of ML in pattern recognition, classification, and regression. The features 608 may be of different types, such as, numeric, strings, categorical, and graph. In some implementations, the feature extractor 606 extracts past content provider settings (e.g., campaign data), content provider objective(s), success rates for content delivery, and/or different Fcap rules used.

The features 608 (e.g., a feature vector) may then be fed to a machine learning (ML) algorithm 610 that trains a model 612. During training, the ML algorithm 610 or ML tool, analyzes the training data based on identified features 608 and configuration parameters defined for the training. Training the ML model 612 involves analyzing large amounts of data (e.g., from several gigabytes to a terabyte or more) in order to find data correlations. The ML algorithm 610 utilizes the training data to find correlations among the identified features 608 that affect the outcome or assessment. In some example implementations, the training data includes labeled data, which is known data for at least one identified feature 608 and at least one outcome. In example implementations, the model 612 may be specifically trained to determine Fcap rules based on the different content provider settings, ongoing objective(s), and success rates. In some implementations, the model may also be trained to determine/adjust other content delivery settings such as resource usage and throttle.

During implementation time, the central control component 402 is configured to determine the content delivery settings. Specifically, the evaluation component 604 determines the dynamic Fcap based on content provider settings, ongoing objective(s), and current content delivery data. In some implementations, the evaluation component 604 may also determine other content delivery settings such as resource usage factors and throttle factors.

The result of the training is the ML model 612 that is capable of taking inputs to produce assessments (e.g., content delivery settings). Subsequently, when the ML model 612 is used to perform an assessment, new data is provided as an input to the ML model 612, and the ML model 612 generates the assessment as output. In some example implementations, results obtained by the model 612 during operation are used to improve the training data, which is then used to generate a newer/updated version of the model 612. Thus, a feedback loop is formed to use the results obtained by the model 612 to improve the model 612.

In example implementations, a feature extractor 614 of the evaluation component 312 receives the input data (e.g., content provider settings, ongoing objective, and current content delivery data) and extracts features. The features are then passed to the model 612, which outputs the content delivery settings including Fcap rules. As with the training component 602, the features in the evaluation component 604 can be passed as a vector (e.g., a feature vector) to the model 612. The model 612 then generates the output (e.g., dynamically generated Fcap rules).

The dynamic Fcap rules can also vary between content based on a content provider's objective (e.g., drive engagement, increase reach). Dynamic Fcap rules can be optimized at each content level to better capture it serving the objective. For example, the objective for C1 is to drive higher engagement and the objective for C2 is to drive higher reach. Thus, C1's dynamic Fcap rule can be once per hour. C2's dynamic Fcap range can be from once per 4 days, because reach is more optimized for a weekly-active individual user, so low frequency will help the content provider to reach more individual audiences.

To combine different content settings, an on-going objective and content delivery situation (e.g., behind schedule, ahead of schedule) are combined together to select a dynamic Fcap rule. In a simple implementation, content objective may use different Fcap ranges, and a Fcap rule is selected within the range based on the content delivery situation. For example, assume C1 is to drive higher engagement, C1's dynamic Fcap rule range is once per hour to once per 4 hours, and assume C2 is to drive higher reach, C2's dynamic Fcap rule range is once per 4 days to once per 1 week. In an advanced ML based implementation, a ML model can be used to take all signals as input (including objective, content settings), and output the most optimal current dynamic Fcap rule in real time.

In some implementations, the central control component 402 includes an analysis component 616. The analysis component 616 analyzes the current content delivery data to determine campaign status (e.g., if a campaign is on schedule, behind schedule, or ahead of schedule; utilization scores; resource usage; content delivery performance) based on different content provider settings. The results of the analysis component 616 is included as part of the content delivery settings that are provided to the serving system 124.

While example implementations provide the training component 602 within the central control component 402, alternative implementations may train the model 612 in a different component within the network system 102. In these implementations, the central control component 402 may only comprise the evaluation component 604 and accesses the model 612 from the different component that trains the model 612. The evaluation component 604 then applies the input data to the model 612.

The techniques described herein may be implemented with privacy safeguards to protect user privacy. Furthermore, the techniques described herein may be implemented with user privacy safeguards to prevent unauthorized access to personal data and confidential data. The training of the models described herein is executed to benefit all users fairly, without causing or amplifying unfair bias.

According to some implementations, the techniques for the models described herein do not make inferences or predictions about individuals unless requested to do so through an input. According to some implementations, the models described herein do not learn from and are not trained on user data without user authorization. In instances where user data is permitted and authorized for use in artificial intelligence (AI) features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some implementations, users may provide feedback while using the techniques described herein, which may be used to improve or modify the platform and products. In some implementations, any personal data associated with a user, such as personal information provided by the user to the platform, may be deleted from storage upon user request. In some implementations, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training models through delexicalisation tools and other privacy enhancing tools for safeguarding user data. The techniques described herein may minimize use of any personal data in training models, including removing and replacing personal data. According to the techniques described herein, notices may be communicated to users to inform how their data is being used and users are provided controls to opt-out from their data being used for training models.

According to some implementations, tools are used with the techniques described herein to identify and mitigate risks associated with AI in all products and AI systems. In some implementations, notices may be provided to users when AI tools are being used to provide features.

It is noted that a similar system as that discussed in FIG. 6 can be used to train a user preference model that identifies user preferences for users based on previous content that each user was presented, interacted with (e.g., clicked on, viewed for a long period of time), or otherwise shown interest in. The trained user preference model can then be used to generate or update user preferences that are stored to the user data storage 308 and 414.

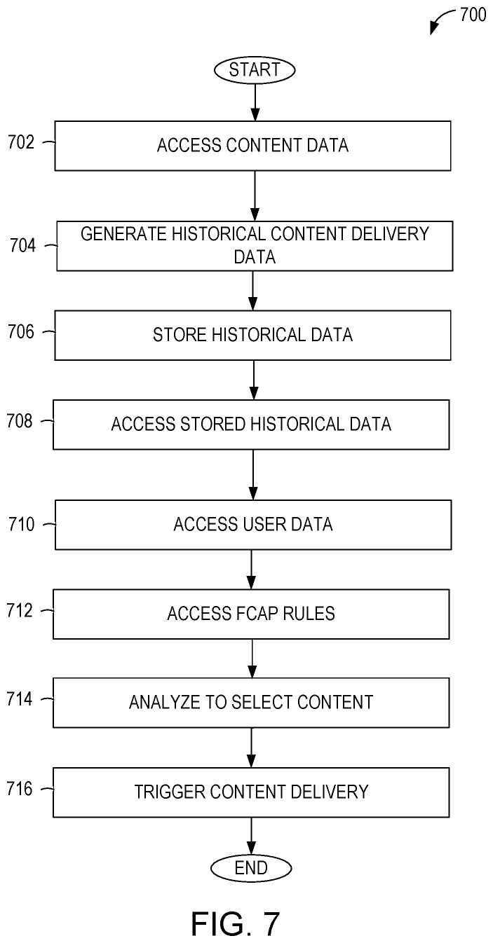

FIG. 7 is a flowchart illustrating operations of a method 700 for dynamically adjusting frequency of content delivery, according to some example implementations. Operations in the method 700 may be performed by the network system 102 and the serving system 126, using components described above with respect to FIGS. 1, 3, and 5. Accordingly, the method 700 is described by way of example with reference to the network system 102 and serving system 126. However, it shall be appreciated that at least some of the operations of the method 700 may be deployed on various other hardware configurations or be performed by similar components residing elsewhere in the network environment 100. Therefore, the method 700 is not intended to be limited to the network system 102 and the serving system 126.

Referring to FIG. 3, the analysis component 302 periodically processes offline jobs to learn or generate historical content delivery data. As such, the analysis component 302 accesses content data from the content data storage 304 in operation 702. The content data can comprise, for example, previous content provider resources or budgets, previous content delivery performance, audience reached with each piece of content, and so forth.

In operation 704, the analysis component 302 uses the content data to generate (or learn) historical content delivery data. In example implementations, the historical content delivery data indicates resource usage (e.g., spending) and delivery over a previous period of time (e.g., last three days) including, for example, one or more utilization scores (e.g., budget utilization) and content delivery performance with different day sliding windows.

In operation 706, the historical content delivery data is stored local and/or remotely. Local storage of the historical content delivery data is to the historical data storage 306. Remote storage of the historical content delivery data includes providing the data to the serving system 126 prior to any serving request from a user. The serving system 126 loads the historical content delivery data into its memory so that the serving system 126 does not need to fetch the historical content delivery data from a remote store (e.g., the historical data storage 306) when the serving request is received, thus reducing latency.

In operation 708, the serving system 126 (e.g., determination component 502) accesses the historical content delivery data stored at the serving system 126 in response to receiving a serving request for a user.

In operation 710, the serving system 126 (e.g., determination component 502) access user data for the user from the user data storage 308. The user data comprises viewed content history (e.g., content that was previously delivered to the user and when the content was delivered) and user preferences of the user. For example, the user preferences can indicate whether the user prefers to see certain content in higher frequency or only wants to see certain content once and loses interest going forward. In example implementations, the user preferences are learned through machine-learning based on past content delivered and interacted (or not interacted) with by the user.

In example implementations, the system of FIG. 3 applies different Fcap rules 310 dynamically. In operation 712, the serving system 126 (e.g., determination component 502) access the Fcap rules 310. The Fcap rules 310 may be accessed and/or stored to the serving system 126. In some cases, the dynamic Fcap rules 310 may be pushed to the serving system by the content system 124. The dynamic Fcap rules 310 are predetermined prior to receiving the request, but dynamically selected in response to the request and based on the historical content delivery data and the user data.

In operation 714, the serving system 126 (e.g., determination component 502) performs analysis to select the content to deliver to the user. The determination component 502 selects the Fcap rule that applies to each piece of content and/or campaign based on the historical content delivery data. Based on the user data and the applied Fcap rules, the determination component 502 selects the piece of content to deliver to the user in response to the request.

In operation 716, the determination component 502 triggers the delivery components 504 to deliver the selected content. For instance, once the content is selected by the determination component 502, the delivery component 504 accesses the selected content from the content storage 506 and transmits the selected content to the user.

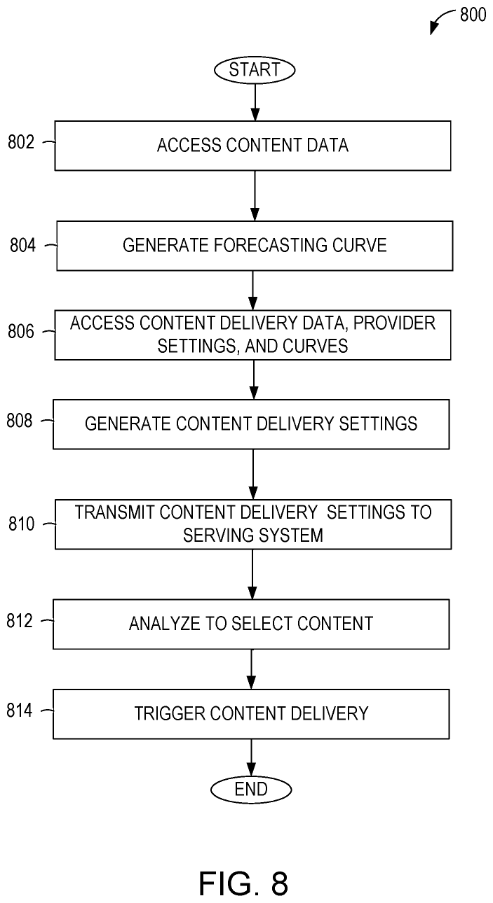

FIG. 8 illustrates a flowchart 800 illustrating operations of another method 800 for dynamically adjusting frequency of content delivery, according to some example implementations. Operations in the method 800 may be performed by the network system 102 and serving system 126, using components described above with respect to FIGS. 1, 4, 5, and 6. Accordingly, the method 800 is described by way of example with reference to the network system 102 and serving system 126. However, it shall be appreciated that at least some of the operations of the method 800 may be deployed on various other hardware configurations or be performed by similar components residing elsewhere in the network environment 100. Therefore, the method 800 is not intended to be limited to the network system 102 and serving system 126.

The method 800 corresponds to the example implementation of FIG. 4 which considers a plurality of different signals in a central manner to avoid potential brain split issues. In particular, the content system 124 of FIG. 4 comprises a central control component 402 that acts as a central brain by receiving signals from different data sources and making a central decision for Fcap, resource usage, throttle, and/or other signals. The input signals can include real-time (or substantially real-time) data.

Some of the input signals include forecasting curves, which can be generated offline. In operation 802, the forecast component 404 access past content data from the past content data storage 410. In operation 804, the forecast component 404 generates the forecasting curves based on the past content data. The forecasting curves can include, for example, a geo-curve and/or a target expression curve. Other types of forecasting curves can also be used.

In operation 806, the central control component 402 accesses current content delivery data (e.g., real-time campaign data or situation), content provider settings, and the generated forecasting curves. The current content delivery data are accessed from the content delivery data storage 406. The current content delivery data can include a campaign budget spending situation for a particular content provider and their content. Thus, the content delivery data can indicate campaign status (e.g., if the campaign is on schedule (e.g., meets a curve projection), behind schedule (e.g., below the curve projection), or ahead of schedule (e.g., higher than the curve projection)). In some implementations, the central control component 402 derives the campaign status from the current content delivery data. The content provider settings are accessed from the setting storage 408 and includes existing content provider settings. These content provider settings are static and may indicate an audience size (e.g., how many users to target) and one or more objectives (e.g., delivery goal such as reach, website visit) established by the content provider. The objective(s) can also be derived by the content system 124 through heuristics or machine learning.

In operation 808, the central control component 402 generates some of the content delivery settings. The central control component 402 takes all of the input signals accessed in operation 806 and generates Fcap rules in addition to other outputs such as a resource usage factor (e.g., bid price) and a throttle factor for each campaign. Thus, the central control component 402 dynamically changes the content provider settings based on current status of content delivery. In example implementations, the central control component 402 uses a machine-learning model to generate some of the content delivery settings (e.g., updated content provider settings), and in particular, the Fcap rules as discussed in connection with FIG. 6. These content delivery settings can be considered live or real-time settings. The content delivery settings can also include the current content delivery data.

In operation 810, the content delivery settings are transmitted to the serving system 126. In example implementations, the generated content delivery settings can be provided to the serving system 126 as soon as they are generated (e.g., in real-time) and are continually updated (e.g., every few minutes). The serving system 126 loads the content delivery settings including the dynamically determined Fcap rules into its memory so that the serving system 126 does not need to fetch the content delivery setting from a remote store when the serving request is received.

In operation 812, the serving system 126 (e.g., determination component 502) performs analysis to select the content to deliver to the user. The Fcap rules are selectively applied to different content based on the other content delivery settings and content delivery data (e.g., current campaign status). Based on the user data and the applied Fcap rules, the serving system 126 (e.g., determination component 502) selects the piece of content to deliver to the user in response to the request.

In operation 814, the determination component 502 triggers the delivery components 504 to deliver the selected content. For instance, once the content is selected by the determination component 502, the delivery component 504 accesses the selected content from the content storage 506 and transmits the selected content to the user.

FIG. 9 illustrates components of a machine 900, according to some example implementations that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 9 shows a diagrammatic representation of the machine 900 in the example form of a computer device (e.g., a computer) and within which instructions 924 (e.g., software, a program, an application, an applet, an app, or other executable code) for causing the machine 900 to perform any one or more of the methodologies discussed herein may be executed, in whole or in part.

For example, the instructions 924 may cause the machine 900 to execute the block and flow diagrams of FIGS. 7 and 8. In one implementation, the instructions 924 can transform the machine 900 into a particular machine (e.g., specially configured machine) programmed to carry out the described and illustrated functions in the manner described.

In alternative implementations, the machine 900 operates as a standalone device or may be connected (e.g., networked) to other machines. In a networked deployment, the machine 900 may operate in the capacity of a server machine or a client machine in a server-client network environment, or as a peer machine in a peer-to-peer (or distributed) network environment. The machine 900 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 924 (sequentially or otherwise) that specify actions to be taken by that machine. Further, while only a single machine is illustrated, the term “machine” shall also be taken to include a collection of machines that individually or jointly execute the instructions 924 to perform any one or more of the methodologies discussed herein.

The machine 900 includes a processor 902 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 904, and a static memory 906, which are configured to communicate with each other via a bus 908. The processor 902 may contain microcircuits that are configurable, temporarily or permanently, by some or all of the instructions 924 such that the processor 902 is configurable to perform any one or more of the methodologies described herein, in whole or in part. For example, a set of one or more microcircuits of the processor 902 may be configurable to execute one or more components described herein.

The machine 900 may further include a graphics display 910 (e.g., a plasma display panel (PDP), a light emitting diode (LED) display, a liquid crystal display (LCD), a projector, or a cathode ray tube (CRT), or any other display capable of displaying graphics or video). The machine 900 may also include an input device 912 (e.g., a keyboard), a cursor control device 914 (e.g., a mouse, a touchpad, a trackball, a joystick, a motion sensor, or other pointing instrument), a storage unit 916, a signal generation device 918 (e.g., a sound card, an amplifier, a speaker, a headphone jack, or any suitable combination thereof), and a network interface device 920.

The storage unit 916 includes a machine-storage medium 922 (e.g., a tangible machine-storage medium) on which is stored the instructions 924 (e.g., software) embodying any one or more of the methodologies or functions described herein. The instructions 924 may also reside, completely or at least partially, within the main memory 904, within the processor 902 (e.g., within the processor's cache memory), or both, before or during execution thereof by the machine 900. Accordingly, the main memory 904 and the processor 902 may be considered as machine-storage media (e.g., tangible and non-transitory machine-storage media). The instructions 924 may be transmitted or received over a network 926 via the network interface device 920.

In some example implementations, the machine 900 may be a portable computing device and have one or more additional input components (e.g., sensors or gauges).

Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

### Executable Instructions and Machine-Storage Medium

The various memories (e.g., 904, 906, and/or memory of the processor(s) 902) and/or storage unit 916 may store one or more sets of instructions and data structures (e.g., software) 924 embodying or utilized by any one or more of the methodologies or functions described herein. These instructions, when executed by processor(s) 902 cause various operations to implement the disclosed implementations.

As used herein, the terms “machine-storage medium,” “device-storage medium,” “computer-storage medium” (referred to collectively as “machine-storage medium 922”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 922 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 922 specifically exclude carrier waves, modulated data signals, and other such media, at least some of which are covered under the term “signal medium” discussed below. In this context, the machine-storage medium is non-transitory.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 924 may further be transmitted or received over a communications network 926 using a transmission medium via the network interface device 920 and utilizing any one of a number of well-known transfer protocols (e.g., HTTP). Examples of communication networks 926 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 924 for execution by the machine 900, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some implementations, a hardware a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example implementations, the one or more processors or processor-implemented components may be located in a single geographic location (e.g., within a home environment, an office environment, or a server farm). In other example implementations, the one or more processors or processor-implemented components may be distributed across a number of geographic locations.

### EXAMPLES

Example 1 is a method to efficiently select and deliver targeted content. The method comprises receiving a request for content, in association with an ongoing objective, to be delivered to a user; in response to receiving the request, accessing, by a central control component of a content system, content delivery data and content provider settings associated with the ongoing objective; based on the content delivery data and the content provider settings, generating, by the central control component, content delivery settings including frequency capping (Fcap) rules for controlling delivery of content according to the ongoing objective; transmitting the content delivery settings to a serving system, the serving system configured to determine content to deliver to the user based on the Fcap rules; accessing, by a determination component of the serving system, user data associated with the user that indicates user preferences; based on the content delivery settings and the user data, selecting, by the determination component of the serving system, a piece of content to deliver to the user; and triggering, by the determination component, a delivery component of the serving system to cause presentation of the piece of content to the user

In example 2, the subject matter of example 1 can optionally include, in response to receiving the request, further accessing one or more forecasting curves, wherein the central control component uses the one or more forecasting curves to ensure delivery is at a pace of the one or more forecasting curves.

In example 3, the subject matter of any of examples 1-2 can optionally include generating the one or more forecasting curves using past content delivery data, wherein the one or more forecasting curves comprises a geo curve or a target expression curve.

In example 4, the subject matter of any of examples 1-3 can optionally include wherein generating the content delivery settings comprises applying one or more of the content delivery data, the content provider settings, or one or more forecasting curves to a machine-learning model.

In example 5, the subject matter of any of examples 1-4 can optionally include training the machine-learning model using past content delivery data; and periodically retraining the machine-learning model using updated past content delivery data.

In example 6, the subject matter of any of examples 1-5 can optionally include wherein generating the content delivery settings further comprises generating a throttle factor that indicates a percentage of content delivery opportunities to consider.

In example 7, the subject matter of any of examples 1-6 can optionally include wherein the generating content delivery settings further comprises generating a resource usage factor that indicates an amount of resources to apply to a content delivery opportunity.

In example 8, the subject matter of any of examples 1-7 can optionally include wherein the content delivery data comprises a current status of a content delivery process for a content provider, the current status indicating whether the content delivery process meets, is below, or is higher than one or more forecasting curves.

In example 9, the subject matter of any of examples 1-8 can optionally include wherein the Fcap rules provide frequency capping control for how many times the user will see a same or similar content within a certain time period.

In example 10, the subject matter of any of examples 1-9 can optionally include wherein generating the content delivery settings comprises dynamically adjusting the Fcap rules to satisfy the ongoing objective.

Example 11 is a system to efficiently select and deliver targeted content. The system includes one or more hardware processors and a memory storing instructions that, when executed by the one or more hardware processors, causes the one or more hardware processors to perform operations comprising receiving a request for content, in association with an ongoing objective, to be delivered to a user; in response to receiving the request, accessing, by a central control component of a content system, content delivery data and content provider settings associated with the ongoing objective; based on the content delivery data and the content provider settings, generating, by the central control component, content delivery settings including frequency capping (Fcap) rules for controlling delivery of content according to the ongoing objective; transmitting the content delivery settings to a serving system, the serving system configured to determine content to deliver to the user based on the Fcap rules; accessing, by a determination component of the serving system, user data associated with the user that indicates user preferences; based on the content delivery settings and the user data, selecting, by the determination component of the serving system, a piece of content to deliver to the user; and triggering, by the determination component, a delivery component of the serving system to cause presentation of the piece of content to the user.

In example 12, the subject matter of example 11 can optionally include wherein the operations further comprise, in response to receiving the request, further accessing one or more forecasting curves, wherein the central control component uses the one or more forecasting curves to ensure delivery is at a pace of the one or more forecasting curves.

In example 13, the subject matter of example 11-12 can optionally include wherein the operations further comprise generating the one or more forecasting curves using past content delivery data, wherein the one or more forecasting curves comprises a geo curve or a target expression curve.

In example 14, the subject matter of example 11-13 can optionally include wherein generating the content delivery settings comprises applying one or more of the content delivery data, the content provider settings, or one or more forecasting curves to a machine-learning model.

In example 15, the subject matter of any of examples 11-14 can optionally include wherein the operations further comprise training the machine-learning model using past content delivery data; and periodically retraining the machine-learning model using updated past content delivery data.

In example 16, the subject matter of any of examples 11-15 can optionally include wherein generating the content delivery settings further comprises generating a throttle factor that indicates a percentage of content delivery opportunities to consider.

In example 17, the subject matter of any of examples 11-16 can optionally include wherein the generating content delivery settings further comprises generating a resource usage factor that indicates an amount of resources to apply to a content delivery opportunity.

In example 18, the subject matter of any of examples 11-17 can optionally include wherein the content delivery data comprises a current status of a content delivery process for a content provider, the current status indicating whether the content delivery process meets, is below, or is higher than one or more forecasting curves.

Example 19 is a machine-storage medium storing instructions that, when executed by at least one hardware processor of a machine, cause the machine to perform operations comprising receiving a request for content, in association with an ongoing objective, to be delivered to a user; in response to receiving the request, accessing, by a central control component of a content system, content delivery data and content provider settings associated with the ongoing objective; based on the content delivery data and the content provider settings, generating, by the central control component, content delivery settings including frequency capping (Fcap) rules for controlling delivery of content according to the ongoing objective; transmitting the content delivery settings to a serving system, the serving system configured to determine content to deliver to the user based on the Fcap rules; accessing, by a determination component of the serving system, user data associated with the user that indicates user preferences; based on the content delivery settings and the user data, selecting, by the determination component of the serving system, a piece of content to deliver to the user; and triggering, by the determination component, a delivery component of the serving system to cause presentation of the piece of content to the user.

In example 20, the subject matter of example 19 can optionally include wherein generating the content delivery settings comprises applying one or more of the content delivery data, the content provider settings, or one or more forecasting curves to a machine-learning model.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various implementations of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method to efficiently select and deliver targeted content, the method comprising:
receiving a request for content, in association with an ongoing objective, to be delivered to a user;
in response to receiving the request, accessing, by a central control component of a content system, content delivery data and content provider settings associated with the ongoing objective;
based on the content delivery data and the content provider settings, generating, by the central control component, content delivery settings including frequency capping (Fcap) rules for controlling delivery of content according to the ongoing objective;
transmitting the content delivery settings to a serving system, the serving system configured to determine content to deliver to the user based on the Fcap rules;
accessing, by a determination component of the serving system, user data associated with the user that indicates user preferences;
based on the content delivery settings and the user data, selecting, by the determination component of the serving system, a piece of content to deliver to the user; and
triggering, by the determination component, a delivery component of the serving system to cause presentation of the piece of content to the user.

2. The method of claim 1, further comprising:
in response to receiving the request, further accessing one or more forecasting curves, wherein the central control component uses the one or more forecasting curves to ensure delivery is at a pace of the one or more forecasting curves.

3. The method of claim 2, further comprising:
generating the one or more forecasting curves using past content delivery data, wherein the one or more forecasting curves comprises a geo curve or a target expression curve.

4. The method of claim 1, wherein generating the content delivery settings comprises applying one or more of the content delivery data, the content provider settings, or one or more forecasting curves to a machine-learning model.

5. The method of claim 4, further comprising:
training the machine-learning model using past content delivery data; and
periodically retraining the machine-learning model using updated past content delivery data.

6. The method of claim 1, wherein generating the content delivery settings further comprises generating a throttle factor that indicates a percentage of content delivery opportunities to consider.

7. The method of claim 1, wherein the generating content delivery settings further comprises generating a resource usage factor that indicates an amount of resources to apply to a content delivery opportunity.

8. The method of claim 1, wherein the content delivery data comprises a current status of a content delivery process for a content provider, the current status indicating whether the content delivery process meets, is below, or is higher than one or more forecasting curves.

9. The method of claim 1, wherein the Fcap rules provide frequency capping control for how many times the user will see a same or similar content within a certain time period.

10. The method of claim 1, wherein generating the content delivery settings comprises dynamically adjusting the Fcap rules to satisfy the ongoing objective.

11. A system comprising:
one or more hardware processors; and
a memory storing instructions that, when executed by the one or more hardware processors, cause the one or more hardware processors to perform operations comprising:
receiving a request for content, in association with an ongoing objective, to be delivered to a user;
in response to receiving the request, accessing, by a central control component of a content system, content delivery data and content provider settings associated with the ongoing objective;
based on the content delivery data and the content provider settings, generating, by the central control component, content delivery settings including frequency capping (Fcap) rules for controlling delivery of content according to the ongoing objective;
transmitting the content delivery settings to a serving system, the serving system configured to determine content to deliver to the user based on the Fcap rules;
accessing, by a determination component of the serving system, user data associated with the user that indicates user preferences;
based on the content delivery settings and the user data, selecting, by the determination component of the serving system, a piece of content to deliver to the user; and
triggering, by the determination component, a delivery component of the serving system to cause presentation of the piece of content to the user.

12. The system of claim 11, wherein the operations further comprise:
in response to receiving the request, further accessing one or more forecasting curves, wherein the central control component uses the one or more forecasting curves to ensure delivery is at a pace of the one or more forecasting curves.

13. The system of claim 12, wherein the operations further comprise:
generating the one or more forecasting curves using past content delivery data, wherein the one or more forecasting curves comprises a geo curve or a target expression curve.

14. The system of claim 11, wherein generating the content delivery settings comprises applying one or more of the content delivery data, the content provider settings, or one or more forecasting curves to a machine-learning model.

15. The system of claim 14, wherein the operations further comprise:
training the machine-learning model using past content delivery data; and
periodically retraining the machine-learning model using updated past content delivery data.

16. The system of claim 11, wherein generating the content delivery settings further comprises generating a throttle factor that indicates a percentage of content delivery opportunities to consider.

17. The system of claim 11, wherein the generating content delivery settings further comprises generating a resource usage factor that indicates an amount of resources to apply to a content delivery opportunity.

18. The system of claim 11, wherein the content delivery data comprises a current status of a content delivery process for a content provider, the current status indicating whether the content delivery process meets, is below, or is higher than one or more forecasting curves.

19. A machine-storage medium comprising instructions which, when executed by one or more processors of a machine, cause the machine to perform operations comprising:
receiving a request for content, in association with an ongoing objective, to be delivered to a user;
in response to receiving the request, accessing, by a central control component of a content system, content delivery data and content provider settings associated with the ongoing objective;
based on the content delivery data and the content provider settings, generating, by the central control component, content delivery settings including frequency capping (Fcap) rules for controlling delivery of content according to the ongoing objective;
transmitting the content delivery settings to a serving system, the serving system configured to determine content to deliver to the user based on the Fcap rules;
accessing, by a determination component of the serving system, user data associated with the user that indicates user preferences based on the content delivery settings and the user data, selecting, by the determination component of the serving system, a piece of content to deliver to the user; and
triggering, by the determination component, a delivery component of the serving system to cause presentation of the piece of content to the user.

20. The machine-storage medium of claim 19, wherein generating the content delivery settings comprises applying one or more of the content delivery data, the content provider settings, or one or more forecasting curves to a machine-learning model.
